(19) United States
(12) Patent Application Publication
(10) Pub. No.: US 2016/0049045 A1
(43) Pub. Date: Feb. 18, 2016

(54) Methods of Administering Wagering Games Involving Multiple Wagers and Wild Cards

(71) Applicant: Bally Gaming, Inc., Las Vegas, NV (US)

(72) Inventor: Roger M. Snow, Las Vegas, NV (US)

(21) Appl. No.: 14/462,346

(22) Filed: Aug. 18, 2014

(51) Int. Cl. G07F 17/32; A63F 1/00

(52) U.S. Cl. CPC G07F 17/3244; A63F 1/00; G07F 17/3293

(57) ABSTRACT

Methods of administering wagering games may involve accepting an ante wager and a blind wager from a player. Five randomized physical cards may be dealt to the player and to the dealer hand from a 53-card deck including a standard 52-card deck of playing cards and one joker, the joker and four deuces being designated as wild cards. A play wager may be accepted from the player to keep the ante and blind wagers in play or a player election to fold may be accepted to forfeit the ante and blind wagers. A payout on the ante and play wagers may be paid when the player hand outranks the dealer hand. A payout on the blind wager may be paid to the player when the player hand outranks the dealer hand and the player hand is one of a set of predetermined winning hands.

### FIELD

This disclosure relates generally to methods of administering wagering games for casinos and other gaming establishments, and related systems and apparatuses. More specifically, disclosed embodiments relate to relate to methods of administering wagering games of poker against a dealer involving multiple wagers and wild cards.

### BACKGROUND

Poker is a popular wagering game played in casinos and other gaming establishments. Many variants of poker have been developed including, for example, five card draw, five card stud, seven card stud, Mississippi Stud™, Texas Hold'em, and Ultimate Texas Hold'em™. However, avid players are generally open to, and sometimes specifically seek out, new and more interesting ways to play poker games, particularly when the reward for a winning outcome at the end of a round of play, or the odds of achieving a winning outcome, may be enhanced.

For example, U.S. Pat. No. 7,628,689, issued Dec. 8, 2009, to Snow, the disclosure of which is incorporated in this application in its entirety by this reference, discloses a poker game. Several quantities of cards dealt and used to form hands are disclosed, and dealing five cards and using five cards to form a hand are among them. The deck used may be a standard, 52-card deck with a joker or jokers added to the deck. At least one playing card indicia may be designated as a wild indicia, but no specific, predetermined indicia (such as deuces) to be made wild are disclosed. Players may be required to make an ante wager on a hand played against a dealer hand and a blind wager against the dealer hand and a pay table of winning player hand outcomes. Players may also make a pair plus bet. Once cards are dealt, the players must make a play wager, or forfeit their ante and blind wagers. The ante and play wagers are paid 1:1 when the player hand outranks the dealer hand and are collected when the dealer hand outranks the player hand. The blind wager is paid when the player hand outranks the dealer hand and is one of a set of predetermined winning hands.

As another example, Deuces Wild, the rules for which are available from the Washington State Gambling Commission website at http://www.wsgc.wa.gov/activities/game-rules/deuces-wild.pdf, is a poker game using a 53-card deck including a joker in which the joker and all deuces are designated as fully wild cards. The rules for Deuces Wild also disclose awarding different payout odds for achieving natural hand ranks than for achieving those same ranks using wild cards.

### BRIEF SUMMARY

In some embodiments, methods of administering wagering games may involve accepting a mandatory ante wager from a player on a game of five-card stud poker played against a dealer hand by receiving a physical, monetarily valuable wagering element in a first designated area on a surface of a gaming table. A mandatory blind wager that a hand dealt to the player will qualify as a predetermined winning hand may be accepted from the player by receiving a physical, monetarily valuable wagering element in a second designated area on the surface of the gaming table, the second designated area being separate and distinct from the first designated area. Five randomized physical cards may be dealt to the player and to the dealer hand from a 53-card deck including a standard 52-card deck of playing cards and one joker, the joker and four deuces being designated as wild cards. A play wager may be accepted from the player by receiving a physical, monetarily valuable wagering element on the surface of the gaming table in a third designated area, responsive to which the ante and blind wagers remain in play by leaving the wagering elements associated with the ante and blind wagers in the first and second designated areas, respectively, or a player election to fold may be accepted, responsive to which the wagering elements associated with the ante and blind wagers are physically collected. The ante and play wagers may be resolved by comparing the dealer hand to a player hand held by the player. A payout on the ante and play wagers may be paid to the player when the player hand outranks the dealer hand by physically transferring wagering elements to the player and the wagering elements associated with the ante and play wagers may be physically collected when the dealer hand outranks the player hand. The blind wager may be resolved by comparing the dealer hand to the player hand and comparing the player hand to a set of predetermined winning hands. A payout on the blind wager may be paid to the player when the player hand outranks the dealer hand and the player hand is a predetermined winning hand by physically transferring wagering elements to the player. The blind wager may be returned to the player (push) when the player hand outranks the dealer hand and the player hand is not a predetermined winning hand by physically transferring the wagering element associated with the blind wager to the player, and the wagering element associated with the blind wager may be physically collected when the dealer hand outranks the player hand, regardless of whether the player hand is a predetermined winning hand.

In other embodiments, methods of administering wagering games may involve accepting a mandatory ante wager from a player on a game of five-card stud poker played against a dealer hand by receiving a physical, monetarily valuable wagering element in a first designated area on a surface of a gaming table. A mandatory blind wager that a hand dealt to the player will qualify as a predetermined winning hand may be accepted from the player by receiving a physical, monetarily valuable wagering element in a second designated area on the surface of the gaming table, the second designated area being separate and distinct from the first designated area. Five randomized physical cards may be dealt to the player and to the dealer hand from a 53-card deck including a standard 52-card deck of playing cards and one joker, the joker and four deuces being designated as wild cards. A mandatory play wager may be accepted from the player by receiving a physical, monetarily valuable wagering element on a third designated area on the surface of the gaming table, responsive to which the ante and blind wagers remain in play by leaving the wagering elements associated with the ante and blind wagers in the first and second designated areas, respectively. The ante and play wagers may be resolved by comparing the dealer hand to a player hand held by the player. A payout on the ante and play wagers may be paid to the player when the player hand outranks the dealer hand by physically transferring wagering elements to the player and the wagering elements associated with the ante and play wagers may be physically collected when the dealer hand outranks the player hand. The blind wager may be resolved by comparing the dealer hand to the player hand and comparing the player hand to a set of predetermined winning hands. A payout on the blind wager may be paid to the player when the player hand outranks the dealer hand and the player hand is a predetermined winning hand by physically transferring wagering elements to the player. The blind wager may be returned to the player when the player hand outranks the dealer hand and the player hand is not a predetermined winning hand by physically transferring the wagering element associated with the blind wager to the player, and the wagering element associated with the blind wager may be physically collected when the dealer hand outranks the player hand, regardless of whether the player hand is a predetermined winning hand.

In some embodiments of the present invention, additional side bet opportunities are provided. Resolution of each side bet may be accomplished using the same revealed player cards, the revealed dealer cards or both the player and dealer cards.

A side bet on the occurrence of a plurality of predetermined winning hands and corresponding payout odds may be provided. In one example, the player 5-card hand must hold 3 of a kind (i.e. “trips”) or better. In one example, 2's are wild and the minimum winning trips bet pays for 3-3's or better. In other examples, 2's are semi-wild. A hand of 3-2's in that example is the minimum winning payout. When 2's are semi-wild, they may be used as a 2 or as a wild card, interchangeably. When 2's are oly wild, 3-2's may be scored as 3-aces. When 2's are semi-wild, 3-2's may be scored as 3-2's or any other trips hand, depending on casino rules. In some examples, 2's must be wild for a highest ranking hand, so if the player draws 4-2's and a joker (i.e., all 5 cards are wild) the highest payout is awarded.

A progressive side bet may be provided that optionally allows the player to make an additional wager. The outcome of the progressive wager is also dependent upon the revealed player cards, revealed dealer cards or combinations thereof. In one example, the bet is automatically lost if the player folds. In other embodiments, this bet and all other optional side bets remain in play after the dealer receives an indication of a fold. In some examples, the progressive is won when the player holds 5 wild cards (2, 2, 2, 2, joker).

In some embodiments, an optional side bet on a two-way bad beat bet is offered by the house. The side bet is resolved in favor of the player when the losing hand (player vs. dealer) is 3-of-a-kind or better. The side bet pays odds payouts for multiple predetermined winning hands.

A coverall side bet may be provided that pays the player when either the player hand or the dealer hand is a four-of-a-kind or better.

Although the 2-way bad beat, trips and progressive bets are optional side bets, they may be offered as mandatory side bets in embodiments. One, two, or all three side bets may be offered in combination with the base game. Combinations of mandatory and optional side bets may also be offered in embodiments.

In still other embodiments, methods of administering wagering games over networks utilizing processors may involve receiving at a server comprising a processor authorization from a player to allocate funds of monetary value to a mandatory ante wager on a game of five-card stud poker played against a dealer hand. The server may receive authorization from the player to allocate funds of monetary value to a mandatory blind wager that a hand dealt to the player will beat the dealer hand and qualify as a predetermined winning hand. The processor may randomly assign rank and suit information correlating to five cards to the player and to the dealer hand from rank and suit information correlating to a 53-card deck including a standard 52-card deck of playing cards and one joker, the joker and four deuces being designated as wild cards. The server may receive authorization from the player to allocate funds to a play wager, responsive to which the ante and blind wagers remain in play, or the server may receive a player election to fold, responsive to which the processor generates authorization to transfer a value of the ante and blind wagers to a house account. The ante and play wagers may be resolved by comparing at the processor the dealer hand to a player hand held by the player. The processor may authorize payment of a payout on the ante and play wagers to the player when the player hand outranks the dealer hand and the processor may authorize transfer of the value of the ante and play wagers to the house account when the dealer hand outranks the player hand. The blind wager may be resolved by comparing at the processor the dealer hand to the player hand and comparing at the processor the player hand to a set of predetermined winning hands. The processor may authorize payment of a payout on the blind wager to the player when the player hand outranks the dealer hand and the player hand is a predetermined winning hand, may authorize transfer of an amount of the blind wager to the player when the player hand outranks the dealer hand and the player hand is not a predetermined winning hand, and may authorize transfer of the amount of the blind wager to the house account when the dealer hand outranks the player hand, regardless of whether the player hand is a predetermined winning hand.

### BRIEF DESCRIPTION OF THE DRAWINGS

While the disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is an enlarged diagram of a player position of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of waging games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 is a flowchart diagram of a method of administering a wagering game, which may be at least partially player-pooled, according to a player-pooled progressive embodiment; and

FIG. 12 is a flowchart diagram of a method of administering a wagering game, which may also be at least partially player-pooled, according to a dividend refund embodiment.

### DETAILED DESCRIPTION

The illustrations presented in this disclosure are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games such as web-based games, casino games, card games, dice games, and other games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked,” “player-banked,” “player-pooled” including “player-pooled progressive,” and “dividend refund” configurations, each of which is described in more detail below) or in wagering games that involve no real-world monetary risks for the player (e.g., the “play-for-fun” and “social play-for-fun” configurations described in more detail below).

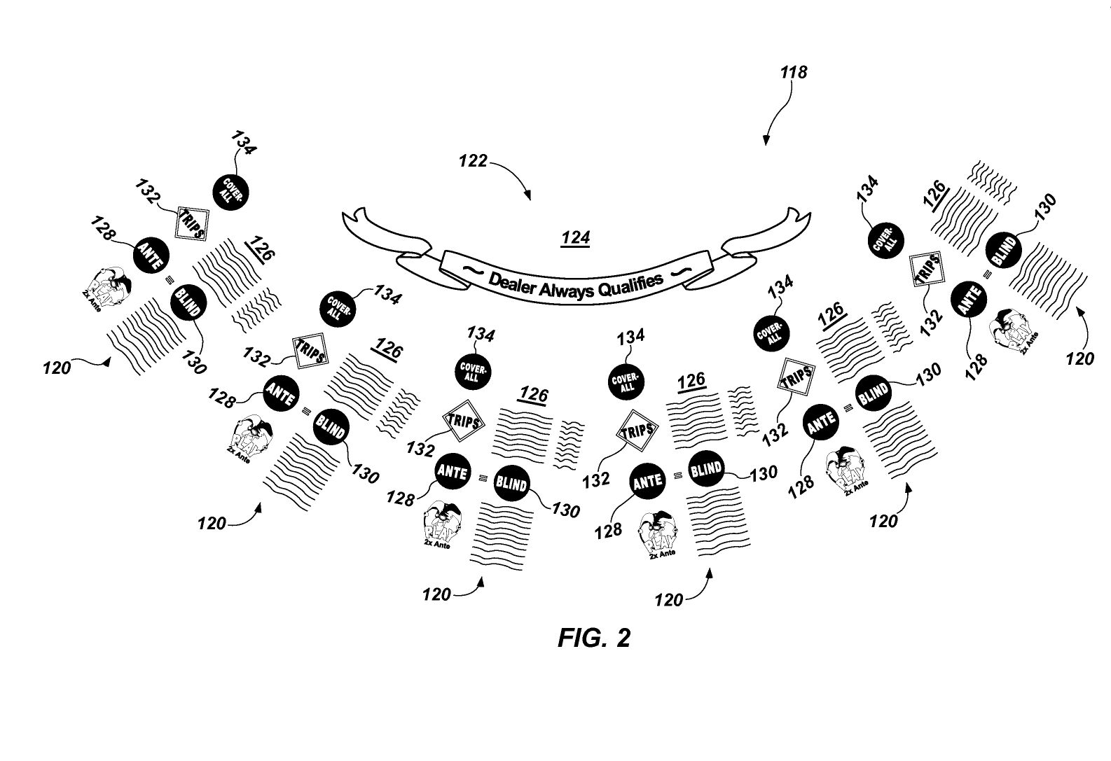

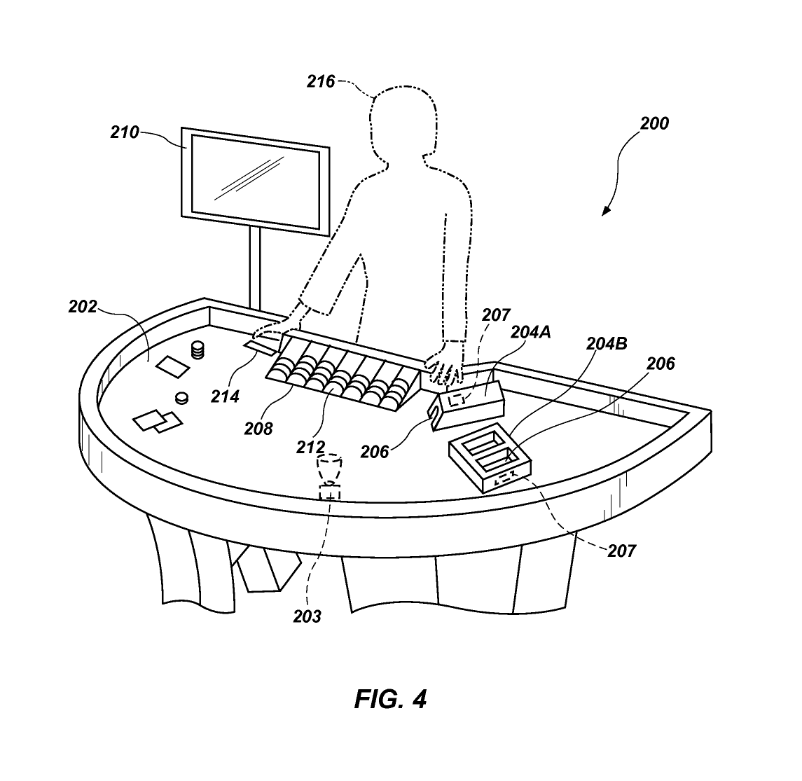

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local gaming table 200, 400, or 500 (see FIGS. 2, 4, 6, and 7), as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device 200, 300, 400, 500, 610, 620, 632, or 640 (see FIGS. 4 through 10). As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer are described, and the description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

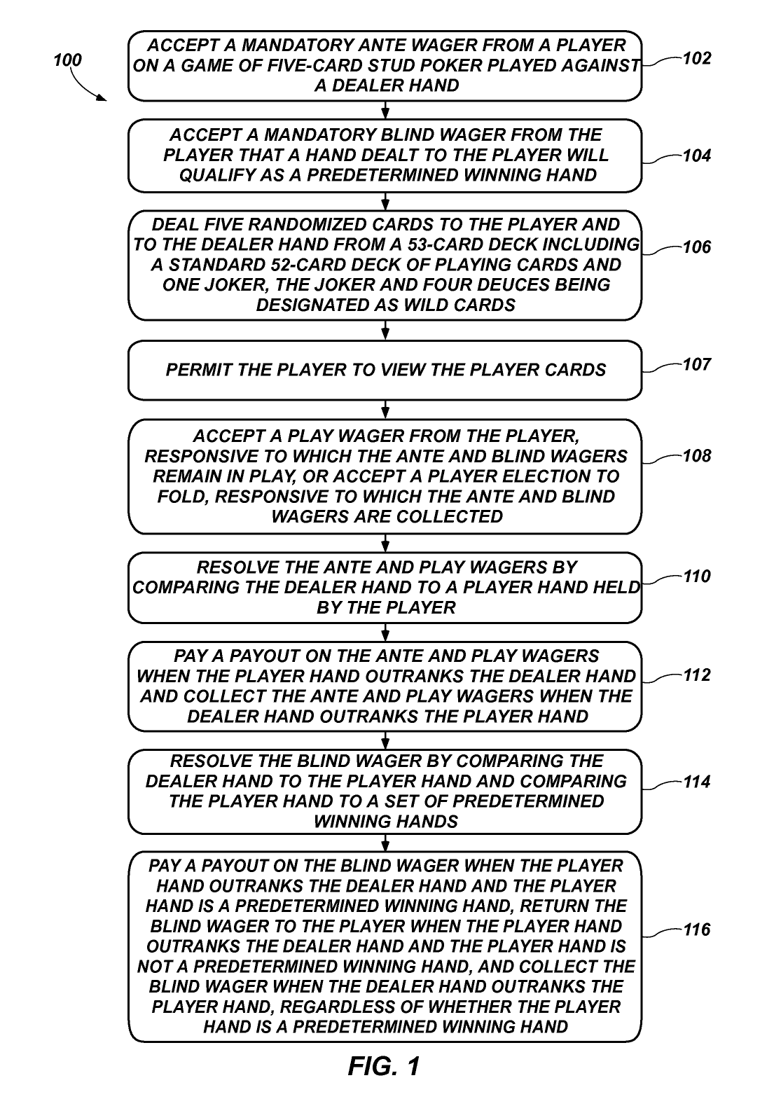

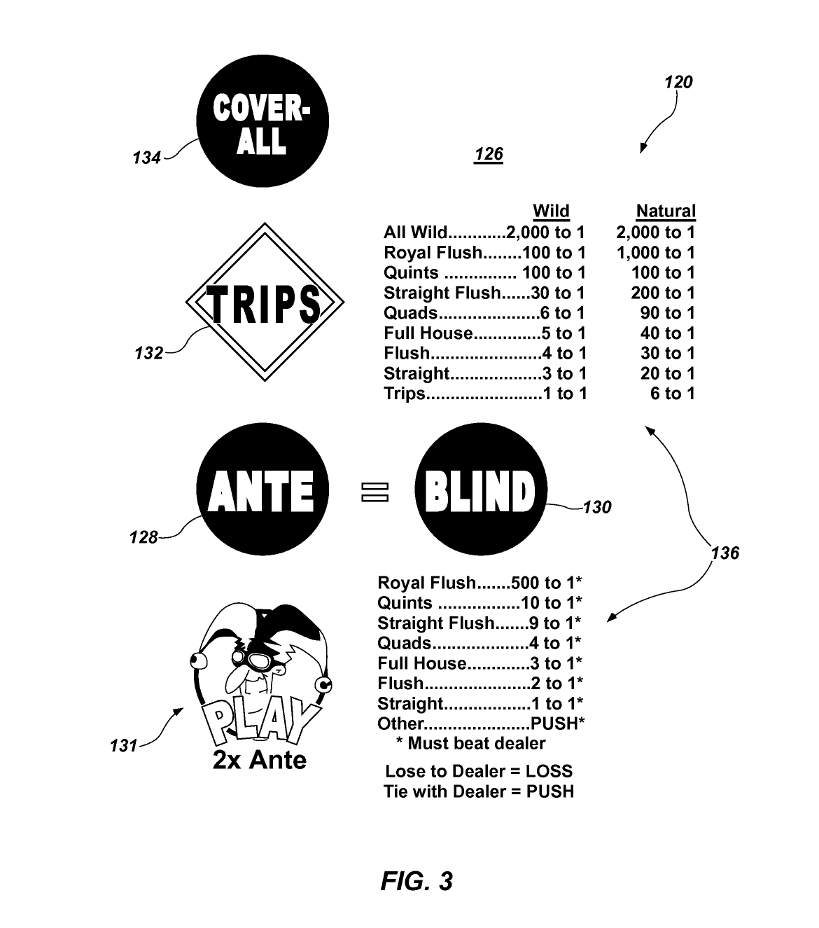

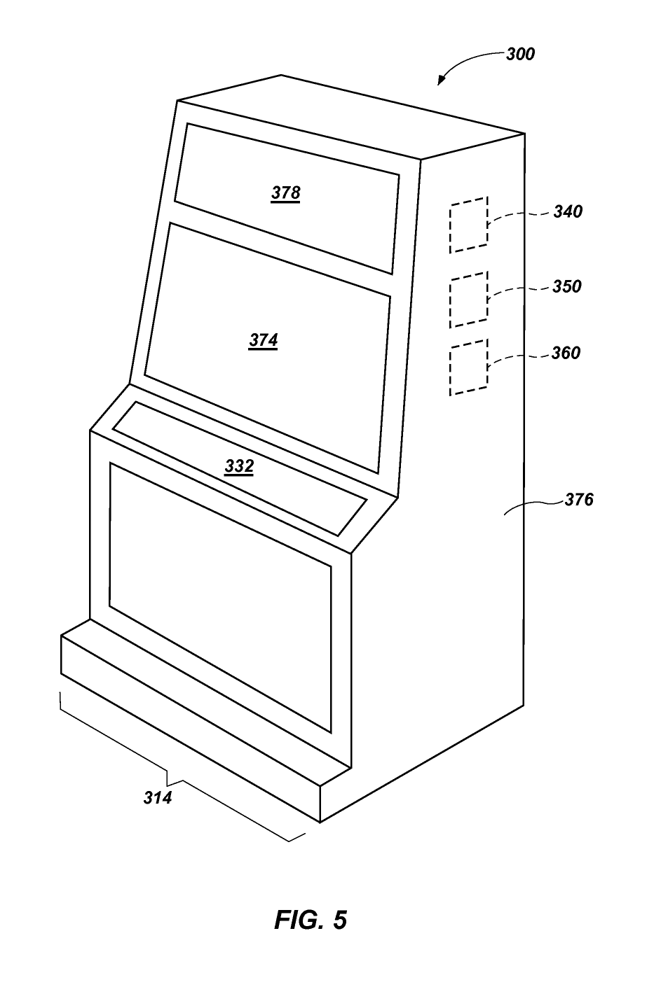

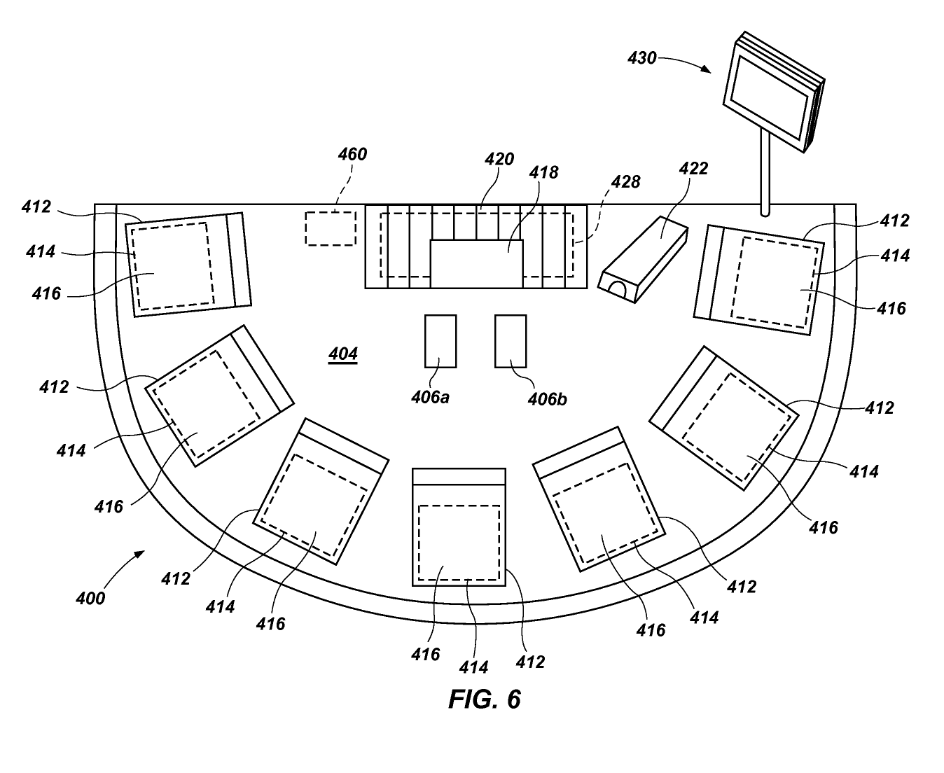

Referring to FIG. 1, a flowchart diagram of an illustrative method 100 of administering a wagering game is shown. The method 100 may involve accepting a mandatory ante wager from a player, as indicated at 102. The mandatory ante wager may be on a game of five-card stud poker played against a dealer hand. Although other amounts of player and dealer cards may be used, such as 3, 4, 6 or 7 card games. The mandatory ante wager may be accepted, for example, by physically receiving money or a representation of money (e.g., a chip or token) on a designated betting area, by a processor receiving a signal from a user interface indicating a wager has been received, or by receiving electronic authorization to charge a player account (e.g., a credit account or a bank account). The ante wager may be accepted, for example, by physically receiving chips within a designated area 128 (see FIGS. 2, 3) on a surface 118 (see FIG. 2) of a gaming table 200, 400, or 500 (see FIGS. 4, 6, 7), by automatically detecting (e.g., using sensors, such as, for example, optical or RFID sensors) the presence of chips within a designated area 128 (see FIGS. 2, 3) on a playing surface 228 of a playing table 200, 400, or 500 (see FIGS. 4, 6, 7), or by receiving electronic authorization at a processor 350, 414, 428, 597, or 642 (see FIGS. 5-7, 10) to charge a player account via a player interface 332, 416, 532, 624, or 644 (see FIGS. 5-8, 10) or dealer interface 418 (see FIG. 6), where the player interface may be remotely located from the dealer or a server of which the processor 350, 414, 428, 597, or 642 (see FIGS. 5-7, 10) is a component. As a specific, nonlimiting example, the mandatory ante wager may be accepted by receiving a physical, monetarily valuable wagering element 212 (see FIG. 4) in a first designated area 128 (see FIGS. 2, 3) on a surface 118 (see FIG. 2) of a gaming table 200, 400, or 500 (see FIGS. 4, 6, 7).

A mandatory blind wager may be accepted from the player, as indicated at 104. An outcome of the mandatory blind wager may depend on whether a hand dealt to the player qualifies as a predetermined winning hand. For example, a set of hands qualifying as predetermined winning hands may be selected before accepting the mandatory blind wager, and the outcome of the mandatory blind wager may depend on whether the hand dealt to the player is one of the predetermined winning hands from the set. More specifically, a fixed set of hands may, for example, qualify as predetermined winning hands, the fixed set may be displayed in a pay table, and the outcome of the mandatory blind wager may depend on whether the hand dealt to the player is one of the hands displayed in the pay table. As a specific, nonlimiting example, a set of hands consisting of a predetermined hand rank and higher-ranked hands may qualify as predetermined winning hands. In some embodiments, an amount of the mandatory blind wager may be equal to an amount of the mandatory ante wager. For example, the monetary or nonmonetary value at risk when the ante wager is accepted may be equal to the additional monetary or nonmonetary value at risk when the blind wager is accepted. The mandatory blind wager may be accepted by performing any of the acts described previously in connection with accepting the mandatory ante wager. As a specific, nonlimiting example, the mandatory blind wager may be accepted by receiving a physical, monetarily valuable wagering element 212 (see FIG. 4) in a second designated area 130 (see FIGS. 2, 3) on the surface 118 (see FIG. 2) of a gaming table 200, 400, or 500 (see FIGS. 4, 6, 7). In some forms of the invention, the player hand rank must also exceed the dealer hand rank to win this wager.

In some embodiments, a trips wager may be accepted from the player. An outcome of the trips wager may depend on whether a hand dealt to the player will be ranked three of a kind or higher. The trips wager may be mandatory in some embodiments. In other embodiments, the trips wager may be optional. The trips wager may be accepted by performing any of the actions described previously in connection with accepting the mandatory ante wager. As a specific, nonlimiting example, the trips wager may be accepted by receiving a physical, monetarily valuable wagering element in a third designated area 132 (see FIGS. 2, 3) on the surface 118 (see FIG. 2) of a gaming table 200, 400, or 500 (see FIGS. 4, 6, 7). The trips wager is automatically lost when the player folds in some examples. In other examples, the trips wager remains in play when the player folds.

In some embodiments, a coverall wager may be accepted from the player. An outcome of the coverall wager may depend on whether a hand dealt to any participating player or the dealer in a given round of play is ranked four of a kind or higher. The coverall wager may be mandatory in some embodiments. In other embodiments, the coverall wager may be optional. The coverall wager may be accepted by performing any of the actions described previously in connection with accepting the mandatory ante wager. As a specific, nonlimiting example, the coverall wager may be accepted by receiving a physical, monetarily valuable wagering element in a fourth designated area 134 (see FIGS. 2, 3) on the surface 118 (see FIG. 2) of a gaming table 200, 400, or 500 (see FIGS. 4, 6, 7). A progressive side bet may be offered that enables a player to optionally make a side bet on the occurrence of a full house or better in the player's hand. The progressive bet may pay a meter payout, such as 100% of the meter for a premium hand of five wild cards (i.e., 2-2-2-2-joker), and may pay a smaller percentage of the meter for lower ranking hands, as well as odds payouts for other even lower ranking hands. The side bet may be optional or mandatory. In one example, the side bet is optional, but the payout is contingent upon the dealer receiving a player election to make a play wager and not a fold election. In other examples, the side bet pays even when the player folds.

A two-way bad beat side wager may also be offered. This wager pays when the losing hand is a predetermined winning rank or higher. A pay table with a plurality of predetermined winning payouts and corresponding payout odds may be provided. The wager may be mandatory or optional. Payouts may be made regardless of whether the player folded, or may require the player to make a play wager.

Five randomized cards may be dealt to the player and to the dealer hand from a 53-card deck, as indicated at 106. The cards may not be dealt until after the mandatory ante, blind, and any trips, bad beat, coverall or progressive wagers have been accepted. The cards may be dealt face down, such that each player's hand is only visible to the respective player and the dealer hand is not visible to any player. The 53-card deck may include a standard 52-card deck of playing cards and one joker. The joker and four deuces may, for example, be designated as wild cards. More specifically, the joker and four deuces may, for example, be used by the player and in the dealer hand to represent a card of any rank and suit. As a specific, nonlimiting example, the joker may be used by the player and in the dealer hand to represent a card of any rank and suit, and the four deuces may be used by the player and in the dealer hand for their displayed rank and suit (i.e., not as wild cards) or to represent a card of any other rank and suit (i.e., as wild cards). In other embodiments, four cards of a different rank, such as Queens, Aces or 5's may instead be designated as wild. The cards may be randomized, for example, by hand-shuffling a physical deck, by machine-shuffling a physical deck using a card-shuffling device 204B (see FIG. 4), or by randomly selecting computer-simulated cards from a computer-simulated deck using a processor 350, 414, 428, 597, or 642 (see FIGS. 5-7, 10). The cards may be dealt, for example, by hand-dealing physical cards from a physical deck, by hand-dealing cards removed from a card-shuffling device 204B (see FIG. 4), by hand delivering groups of cards randomized by a card-shuffling device 204B or by displaying computer-simulated cards on an electronic display device 210, 332, 374, 404, 416, 430, 560, 564, 532, 622, 658, and 688 (see FIGS. 4-7, 9, 10).

At operation 107, the player cards are revealed to the player. The player may then make a fold vs. play bet election on the basis of the strength of the player's hand.

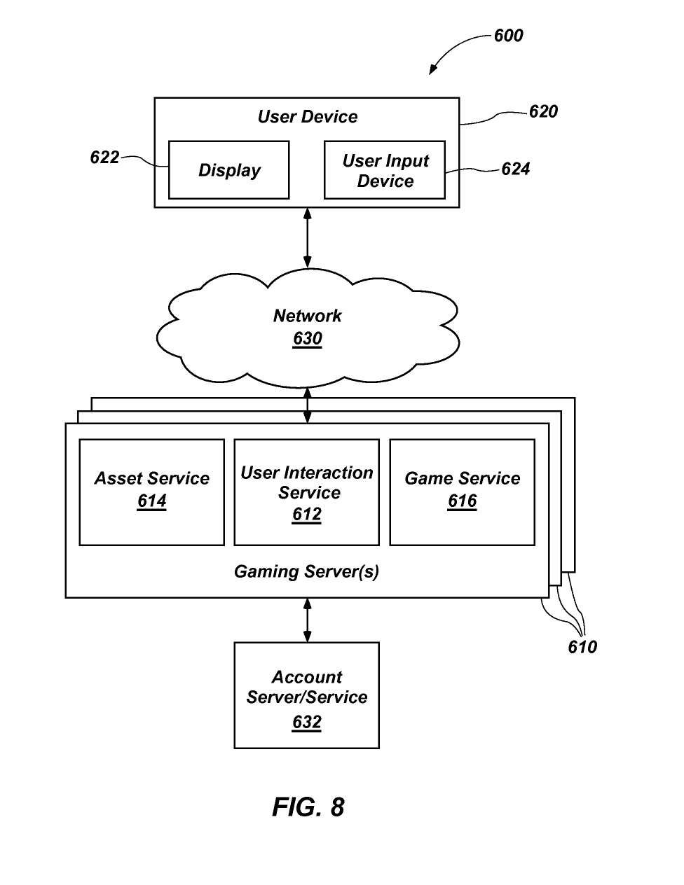

After the player is permitted to view his cards, at operation 107, a play wager or an election to fold may be accepted from the player, as indicated at 108. When a play wager is accepted, the ante and blind wagers may remain in play. For example, the amounts accepted for the ante and blind wagers from the player may remain at risk when the play wager is accepted from the player. As a specific, nonlimiting example, physical, monetarily valuable wagering elements associated with the ante and blind wagers may be left in the first and second designated areas 128 and 130 (see FIGS. 2, 3) on the surface 118 (see FIG. 2) of the gaming table 200, 400, or 500 (see FIGS. 4, 6, 7), respectively. The play wager may be accepted in designated area 131 (FIG. 3) by performing any of the acts described previously in connection with accepting the ante wager. As a specific, nonlimiting example, the play wager may be accepted by receiving a physical, monetarily valuable wagering element on the surface 118 (see FIG. 2) of a gaming table 200, 400, or 500 (see FIGS. 4, 6, 7), such as, for example, in the third designated area 131 (see FIGS. 2, 3). When a player's election to fold is accepted, the wagering elements associated with the ante and blind wagers may be collected by the dealer for the house. A player's election to fold may be accepted, for example, by visually or aurally receiving a player's indication that the player elects to fold and acceding to that indication or receiving at a processor 350, 414, 428, 597, or 642 (see FIGS. 5-7, 10) an electronic indication that the player elects to fold via a player interface 332, 416, 532, 624, or 644 (see FIGS. 5-8, 10) or dealer interface 418 (see FIG. 6). The wagering elements associated with the ante and blind wagers may be collected for the house, for example, by physically retrieving the wagering elements associated with the ante and blind wagers from the surface 118 (see FIG. 2) of the gaming table 200, 400, or 500 (see FIGS. 4, 6, 7) and transferring them to a rack 208 or 420 (see FIGS. 4, 6) of house wagering elements or generating electronic authorization (e.g., automatically or in response to a player or dealer input) at a processor 350, 414, 428, 597, or 642 (see FIGS. 5-7, 10) to transfer amounts of the ante and blind wagers to a house account 632 (see FIG. 8). The play wager may be optional in some embodiments. In other embodiments, the play wager may be mandatory, in which case any attempt by a player to fold may not be accepted. In yet other embodiments, a player may be required to make the Ante, Blind and play bet before viewing any cards and the player may not elect to fold. In other wods, the player may be required to play “blind”.

In some embodiments, the trips wager may remain in play when the player's election to fold is accepted. In other embodiments, the trips wager may be collected for the house when the player's election to fold is accepted. In some embodiments, the coverall wager may remain at risk when the player's election to fold is accepted. In other embodiments, the coverall wager may be collected for the house when the player's election to fold is accepted.

Any one or more side wagers (for example, Trips, Progressive, Coverall, Two-way bad beat, may be offered individually or in combination with the primary game. One or more of the side wagers may be mandatory. In other embodiments, all side wagers are optional. One or more side wagers may lose if the player folds. In other examples, all side bets stay in action regardless of whether the player elects to fold or make a player wager.

The ante and play wagers may be resolved by comparing the dealer hand to a player hand held by the player, as indicated at 110. For example, the dealer may reveal the dealer hand, the player hand may be revealed, and the dealer may visually inspect the hands to determine which is of higher rank; the dealer may reveal the dealer hand, the player hand may be revealed, and the hands may be electronically inspected (e.g., using sensors, such as, for example, optical or RFID sensors) to determine which is of higher rank; or computer-simulated hands may be electronically inspected at a processor 350, 414, 428, 597, or 642 (see FIGS. 5-7, 10) to determine which is of higher rank. As a specific, nonlimiting example, the dealer may physically turn cards of the dealer hand face up. Cards of the player hand may be physically turned face up, and the hands may be visually inspected by the dealer to determine which hand is of higher rank. The player hand and the dealer hand may be ranked according to known five-card poker rankings for games played with wild cards (e.g., in descending order: all wild cards, royal flush, straight flush, five of a kind, four of a kind, full house, flush, straight, three of a kind, two pair, one pair, and high card). In some embodiments, hands formed with wild cards have lower payouts than natural hands of the same rank without wild cards.

A payout on the ante and play wagers may be paid to the player when the player hand outranks the dealer hand, as indicated at 112. An amount of the payout may be proportional to the amounts risked when the ante and play wagers were accepted. For example, the amount of the payout may be equal to the amounts risked when the ante and play wagers were accepted (i.e., a 1:1 payout). Paying the payout may involve, for example, physically giving money or chips, crediting a win meter, or granting electronic authorization to transfer funds to a player account. More specifically, the payout may be paid, for example, by physically giving chips to a player on a playing surface 118 (see FIG. 2) of a gaming table 200, 400, or 500 (see FIGS. 4, 6, 7), by receiving electronic authorization at a processor 350, 414, 428, 597, or 642 (see FIGS. 5-7, 10) via a dealer interface 418 (see FIG. 6) to transfer funds from a house account server 632 (see FIG. 8) to a player account, or automatically generating electronic authorization at the processor 350, 414, 428, 597, or 642 (see FIGS. 5-7, 10) to transfer funds from an account server 632 (see FIG. 8) to a player account. As a specific, nonlimiting example, the payout on the ante and play wagers may be paid by physically transferring wagering elements from a rack 208 or 420 (see FIGS. 4, 6) to the player.

When the dealer hand outranks the player hand, the ante and play wagers may be collected for the house. For example, the ante and play wagers may be collected by performing any of the acts described previously in connection with collecting the ante and blind wagers in response to accepting an election to fold. When the dealer hand is of the same rank as the player hand (i.e., when the hands tie), the amounts of the ante and play wagers may be returned to the player (i.e., the wagers may be a “push”). For example, the amounts of the ante and play wagers may be returned to the player by physically transferring chips associated with the ante and play wagers to the player or by generating electronic authorization at a processor 350, 414, 428, 597, or 642 (see FIGS. 5-7, 10) (e.g., automatically or in response to a dealer input) to transfer the amounts of the ante and play wagers back to a player account. As a specific, nonlimiting example, the amounts of the ante and play wagers may be returned to the player by physically displacing chips associated with the ante and play wagers out of a designated area 128 (see FIGS. 2, 3) on the surface 118 (see FIG. 2) of a gaming table 200, 400, or 500 (see FIGS. 4, 6, 7) and moving them closer to the player or a stack of chips in possession and control of the player.

The blind wager may be resolved by comparing the dealer hand to the player hand and comparing the player hand to a set of predetermined winning hands, as indicated at 114. The dealer hand may be compared to the player hand by performing any of the acts described previously in connection with resolving the ante and play wagers. If the player hand rank is higher than the dealer hand rank, the player hand may be compared to a set of predetermined winning hands by, for example, revealing the player hand and visually inspecting the player hand and a displayed set of predetermined winning hands to determine whether a rank of the player hand is the same as the rank of any of the predetermined winning hands. The player hand may be revealedelectronically inspected (e.g., using sensors, such as, for example, optical or RFID sensors), and electronically accessed (e.g., in memory 340, 595, or 646 (see FIGS. 5, 7, 10)), for example by comparing its rank to a stored set of predetermined winning hands to determine whether a rank of the player hand is the same as the rank of any of the predetermined winning hands; or computer-simulated hands may be electronically inspected at a processor 350, 414, 428, 597, or 642 (see FIGS. 5-7, 10) to determine whether a rank of the player hand is the same as the rank of any of the predetermined winning hands. As a specific, nonlimiting example, the cards of the player hand may be physically turned face up and the player hand may be visually compared by the dealer to a pay table listing hands qualifying as predetermined winning hands to determine whether a rank of the player hand is the same as the rank of any of the predetermined winning hands.

A payout on the blind wager may be paid to the player when the player hand outranks the dealer hand and the player hand is a predetermined winning hand, as indicated at 116. The payout may be paid to the player by, for example, performing any of the actions described previously in connection with paying the payout on the ante and play wagers. As a specific, nonlimiting example, the payout on the blind wager may be paid to the player by physically transferring wagering elements from a rack 208 or 420 (see FIGS. 4, 6) to the player. An amount of the payout may depend on, for example, a rank of a predetermined winning hand achieved by the player. For example, the amount of the payout may increase for increasingly-difficult-to-achieve hands. As a specific, nonlimiting example, the amount of the payout on the blind wager may be according to the following pay table:

TABLE A

| Predetermined Winning | | |
|---|---|---|
| Player Hand Achieved | Payout | |
| Five Wilds | 1000:1 | 1000:1 |
| Royal Hush | 50:1* | 50:1 |
| Five of a Kind | 10:1* | 10:1 |
| Straight Flush | 9:1 | 9:1 |
| Four of a Kind | 4:1* | 5:1 |
| Full House | 3:1* | 4:1 |
| Flush | 2:1* | 2:1 |
| Straight | 1:1* | 1:1 |
| Other | Push | Push |

*Must beat dealer hand. Payouts may be the same for natural and non-natural hands.

The blind wager may be returned to the player when the player hand outranks the dealer hand and the player hand is not a predetermined winning hand (i.e., the blind wager may be a push), as further indicated at 116. The blind wager may be returned to the player by performing any of the acts described previously in connection with returning the ante and play wagers to the player. As a specific, nonlimiting example, the amount of the blind wager may be returned to the player by physically displacing a chip associated with the blind wager out of a designated area 130 (see FIGS. 2, 3) on the surface 118 (see FIG. 2) of a gaming table 200, 400, or 500 (see FIGS. 4, 6, 7) and moving them closer to the player or a stack of chips in possession and control of the player.

The blind wager may be collected for the house when the dealer hand outranks the player hand, regardless of whether the player hand is a predetermined winning hand, as still further indicated at 116. For example, the blind wager may be collected by performing any of the acts described previously in connection with collecting the ante and blind wagers in response to accepting an election to fold.

The trips wager may be resolved by determining whether the player hand is ranked three of a kind or higher. For example, the player hand may be revealed and the dealer may visually inspect the player hand to determine whether the player hand is ranked three of a kind or higher; the player hand may be revealed and the player hand may be electronically inspected (e.g., using sensors, such as, for example, optical or RFID sensors) to determine whether the player hand is ranked three of a kind or higher; or a computer-simulated player hand may be electronically inspected at a processor 350, 414, 428, 597, or 642 (see FIGS. 5-7, 10) to determine whether the player hand is ranked three of a kind or higher. As a specific, nonlimiting example, the cards of the player hand may be physically turned face up and the player hand may be visually inspected by the dealer to determine whether the player hand is ranked three of a kind or higher.

A payout on the trips wager may be paid to the player when the player hand is ranked three of a kind or higher. The payout may be paid by performing any of the actions described previously in connection with paying the payout on the ante and play wagers. As a specific, nonlimiting example, the payout on the trips wager may be paid by physically transferring wagering elements from a rack 208 or 420 (see FIGS. 4, 6) to the player. An amount of the payout may increase as the likelihood of dealing the specific hand achieved by the player decreases. An amount of the payout may also be greater when the player hand is a natural, such that the hand achieves its rank without using any wild card as a wild card than when the player hand achieves its rank using a wild card as a wild card. For example, the amount of the payout may be between five and ten times greater when the player hand achieves its rank without using a joker or using a deuce as anything other than its displayed rank and suit than when the player hand achieves its rank using a joker or using a deuce as something other than its displayed rank, suit, or both. In some embodiments, the payout associated with achieving some hands may be the same regardless of whether a wild card was used as a wild card. In other embodiments, the payout may always be greater for achieving a given rank without using a wild card as a wild card than when the rank is achieved using a wild card as a wild card. As a specific, nonlimiting example, the amount of the payout on the trips wager may be determined according to the following pay table:

TABLE B
Trips

| Paytable 1 | | | Paytable 2 | | Paytable 3 | |
|---|---|---|---|---|---|---|
| Hand | Natural | Wild | Natural | Wild | Natural | Wild |
| All Wild | 2,000 to 1 | | 2,000 to 1 | | 2,000 to 1 | |
| Royal Flush | 1,000 to 1 | 100 to 1 | 1,000 to 1 | 100 to 1 | 1,000 to 1 | 100 to 1 |
| Five of a Kind | 100 to 1 | | 100 to 1 | | 100 to 1 | |
| Straight Flush | 200 to 1 | 30 to 1 | 200 to 1 | 30 to 1 | 200 to 1 | 30 to 1 |
| Four of a Kind | 90 to 1 | 6 to 1 | 90 to 1 | 6 to 1 | 90 to 1 | 6 to 1 |
| Full House | 40 to 1 | 5 to 1 | 40 to 1 | 5 to 1 | 30 to 1 | 5 to 1 |
| Flush | 25 to 1 | 4 to 1 | 30 to 1 | 4 to 1 | 25 to 1 | 4 to 1 |
| Straight | 20 to 1 | 3 to 1 | 20 to 1 | 3 to 1 | 20 to 1 | 3 to 1 |
| Trips | 7 to 1 | 1 to 1 | 6 to 1 | 1 to 1 | 6 to 1 | 1 to 1 |

The amount of the trips wager may be collected for the house when the player hand is ranks lower than three of a kind. The trips wager may be collected by performing any of the acts described previously in connection with collecting the ante and play wagers.

The coverall wager may be resolved by determining whether a hand held by any player or the dealer is ranked four of a kind or higher. For example, the dealer may reveal the dealer hand, each player hand may be revealed, and the dealer may visually inspect each hand to determine whether any hand is ranked four of a kind or higher; the dealer may reveal the dealer hand, each player hand may be revealed and each hand may be electronically inspected (e.g., using sensors, such as, for example, optical or RFID sensors) to determine whether any hand is ranked four of a kind or higher; or each computer-simulated player hand and a computer-simulated dealer hand may be electronically inspected at a processor 350, 414, 428, 597, or 642 (see FIGS. 5-7, 10) to determine whether any hand is ranked four of a kind or higher. As a specific, nonlimiting example, the dealer may physically turn the cards of the dealer hand face up, the cards of each player hand may be physically turned face up, and each hand may be visually inspected by the dealer to determine whether any hand is ranked four of a kind or higher.

A payout on the coverall wager may be paid to the player any player hand or the dealer hand is ranked four of a kind or higher. The payout may be paid by performing any of the actions described previously in connection with paying the payout on the ante and play wagers. As a specific, nonlimiting example, the payout on the coverall wager may be paid by physically transferring wagering elements from a rack 208 or 420 (see FIGS. 4, 6) to the player. In some embodiments, multiple, separate payouts on the coverall wager may be paid to each player who initially placed an optional coverall wager when any player or the dealer is dealt a four of a kind or higher. In other embodiments, a single payout on the coverall wager may be divided among each player who initially placed an optional coverall wager when any player or the dealer is dealt a four of a kind or higher. An amount of the payout may increase as the likelihood of dealing the specific hand achieved by any player or the dealer decreases. An amount of the payout may also increase as the number of participating players decreases. In some embodiments, the payout associated with achieving some hands may be the same regardless of how many players are participating. In other embodiments, the payout may always be greater as the number of players decreases. As a specific, nonlimiting example, the amount of the payout on the coverall wager may be determined according to the following pay table:

TABLE C

| | Payout | Payout | Payout | Payout | Payout | Payout |
|---|---|---|---|---|---|---|
| Hand | with 1 | with 2 | with 3 | with 4 | with 5 | with 6 |
| Achieved | Player | Players | Players | Players | Players | Players |
| All Wilds | 500:1 | 500:1 | 500:1 | 500:1 | 500:1 | 500:1 |
| Royal Flush | 200:1 | 125:1 | 100:1 | 75:1 | 60:1 | 50:1 |
| Straight Flush | 75:1 | 60:1 | 50:1 | 35:1 | 30:1 | 30:1 |
| Five of a Kind | 50:1 | 40:1 | 30:1 | 25:1 | 20:1 | 20:1 |
| Four of a Kind | 15:1 | 9:1 | 6:1 | 5:1 | 4:1 | 3:1 |

The amount of the coverall wager may be collected for the house when all of the player hands and the dealer hand are ranked lower than four of a kind. The coverall wager may be collected by performing any of the acts described previously in connection with collecting the ante and play wagers.

An illustrative two-way bad beat payout pay table may be used to resolve the bad beat side bet as shown in Table D:

| Hand | Odds Payout | Odds Payout |
|---|---|---|
| Royal Flush | 500:1 | 1,000:1 |
| 5 of a Kind | 500:1 | 1,000:1 |
| Straight Flush | 500:1 | 5,000:1 |
| Four of a Kind | 500:1 | 500:1 |
| Full House | 400:1 | 400:1 |
| Flush | 300:1 | 300:1 |
| Straight | 100:1 | 100:1 |
| 3 of a Kind | 9:1 | 9:1 |

An illustrative pay table for a progressive side bet is shown in Table E. The top two prizes are a percent of the progressive meter, while the other payouts are absolute amounts. In other embodiments, the other payouts are odds payouts. Smaller payouts, such as $200 and below may be made from the chip tray rather than from the amount on the meter. The progressive side bet may be administered with a system such as one described in U.S. Pat. No. 5,364,105, the content of which is hereby incorporated by reference in its entirety.

TABLE E

| Hand | Progressive Payout | Odds Payout |
|---|---|---|
| Five Wilds | 100% | |
| Natural Royal Flush | 10% | |
| Wild Royal Flush | | $200 |
| Five of a Kind | | $150 |
| Straight Flush | | $50 |
| Four of a Kind | | $10 |
| Full House | | $9 |

Various platforms are contemplated that are suitable for implementation of embodiments of wagering games according to this disclosure. For example, embodiments of wagering games may be implemented as live table games with an in-person dealer, electronic gaming machines, partially or fully automated table games, and partially or fully automated, network-administered games (e.g., Internet games) wherein game results may be produced utilizing a processor or a live video feed of a dealer administering a game from a remote studio.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally-authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

Referring to FIG. 2, shown is a diagram of a playing surface 118 for implementation of the wagering games within the scope of the present disclosure. Such an implementation may be, for example, a felt layout on a physical gaming table 200 or 400 (see FIGS. 4, 6) or an electronic representation on a video display 374, 416, 430, 532, 564, 560, 658, or 688 (see FIGS. 5-7, 9, 10) for each participating player position 120. The playing surface 118 may include player positions 120 with which players may interact and a dealer position 122 with which the dealer may interact and within each of which the activity (e.g., wagering and card dealing) may take place. The dealer position 122 may be, for example, an area 124 within which cards may be dealt to the dealer hand.

Referring to FIG. 3, illustrated is an enlarged diagram of one of the player positions 120 of the playing surface 118 of FIG. 2. Each player position 120 may include an area 126 within which cards may be dealt to the player. Each player position 120 may further include a first designated area 128 configured for accepting the ante wager, a second designated area 130 configured for accepting the blind wager, and a third area 131 for accepting a play wager. In some embodiments, each player position 120 may include another designated area 132 configured for accepting the trips wager. In some embodiments, each player position 120 may include yet another designated area 134 configured for accepting the coverall wager. It is to be understood that a separate wager area is provided for each side bet offered. Each of the first, second, third, and fourth designated areas 128 through 134 may be separate and distinct from one another. In some embodiments, each player position 120 may include pay tables 136 displaying payouts associated with the wagers.

The results of actions performed when administering wagering games in accordance with this disclosure may be reflected on the playing surface 118. For example, a mandatory ante wager may be accepted from a player, which may be reflected by the presence of a physical wagering element or the display of a computer-simulated wagering element in the first designated area 128. A mandatory blind wager may be accepted from the player, which may be reflected by the presence of a physical wagering element or the display of a computer-simulated wagering element in the second designated area 130. In some embodiments, a trips wager may be accepted from the player, which may be reflected by the presence of a physical wagering element or the display of a computer-simulated wagering element in the third designated area 132. In some embodiments, a coverall wager may be accepted from the player, which may be reflected by the presence of a physical wagering element or the display of a computer-simulated wagering element in the fourth designated area 134.

Five cards may be dealt to each participating player and to a dealer hand from a 53-card deck composed of a standard 52-card deck of playing cards and one joker, which may be reflected by the presence of five physical cards or the display of five computer-simulated cards in the area 126 of each player position 120. The cards may be dealt face down, and players may be permitted to inspect their respective cards. Once each player has viewed the player hand dealt to the respective player, a play wager or an election to fold may be accepted from each player, which may be reflected by the presence of an additional physical wagering element or the display of an additional computer-simulated wagering element in a player's respective player position 120 (e.g., in the first designated area 128) or by the physical removal of at least some wagering elements from or cessation of displaying at least some wagering elements within a player's respective player position 120 (e.g., from the first and second designated areas 128 and 130, and from the third and fourth designated areas 132 and 134, when applicable).

The ante and play wagers may be resolved by comparing the dealer hand to a player hand held by the player. A payout on the ante and play wagers may be paid to the player when the player hand outranks the dealer hand, which may be reflected by the presence of physical wagering elements in the player position 120 or the electronic transfer of funds to a player account. When the dealer hand outranks the player hand, the ante and play wagers may be collected for the house, which may be reflected by the physical removal of wagering elements from or cessation of displaying wagering elements within a player's respective player position 120. When the dealer hand is of the same rank as the player hand, the amounts of the ante and play wagers may be returned to the player, which may be reflected by moving the physical wagering elements associated with the ante and play wagers closer to the player within the player position 120 or electronically transferring funds to a player account.

The blind wager may be resolved by comparing the dealer hand to a player hand held by the player and by comparing the player hand to a set of predetermined winning hands. A payout on the blind wager may be paid to the player when the player hand outranks the dealer hand and the player hand is a predetermined winning hand, which may be reflected by the presence of physical wagering elements in the player position 120 or the electronic transfer of funds to a player account. When the player hand outranks the dealer hand, but the player hand is not a predetermined winning hand, the blind wager may be returned to the player, which may be reflected by moving the physical wagering elements associated with the ante and play wagers closer to the player within the player position 120 or electronically transferring funds to a player account. When the dealer hand outranks the player hand, the blind wager may be collected for the house without regard to whether the player hand is a predetermined winning hand, which may be reflected by the physical removal of wagering elements to a rack 208 or 420 (see FIGS. 4, 6) from or cessation of displaying wagering elements within a player's respective player position 120.

The trips wager may be resolved by determining whether the player hand is a three of a kind or higher. A payout on the trips wager may be paid to the player when the player hand is a three of a kind or higher, which may be reflected by the presence of physical wagering elements in the player position 120 or the electronic transfer of funds to a player account. When the player hand is not a three of a kind, the trips wager may be collected for the house, which may be reflected by the physical removal of wagering elements from or cessation of displaying wagering elements within a player's respective player position 120.

The coverall wager may be resolved by determining whether any participating player's hand or the dealer hand is a four of a kind or higher. A payout on the coverall wager may be paid to the player when any player hand or the dealer hand is a four of a kind or higher, which may be reflected by the presence of physical wagering elements in the player position 120 or the electronic transfer of funds to a player account. When all player hands and the dealer hand are not a three of a kind or higher, the coverall wager may be collected for the house, which may be reflected by the physical removal of wagering elements from or cessation of displaying wagering elements within a player's respective player position 120.

The progressive wager and Beat Beat wagers may be resolved by comparing the player hand rank to a paytable of predetermined winning hands and a corresponding payout or payout odds.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented in the form of a live table game, in a virtual table game, in an electronic game, or in a networked (e.g., Internet) game configuration.

In other embodiments, the wagering games, or at least one wager associated with the wagering game, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, paytables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time. Such a card-handling device 204A may include, for example, a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference.

The card-handling device 204B may be, for example, a shuffler configured to reorder physical cards 206 from one or more decks of playing cards and present randomized cards 206 for use in the wagering game. Such a card-handling device 204B may include, for example, a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. Shufflers such as the devices disclosed in the '574 Patent may include card recognition capability and may form randomly ordered hands of a known composition within the shuffler. Additionally, game rules may also be programmed within the shuffler such that the processor of the shuffler is capable of identifying a winning hand prior to automatic delivery into an output tray. The card-handling device 204 may also be, for example, a combination shuffler and shoe in which the output for the shuffler is a shoe.

For example, the shuffler may be programmed to deliver random five-card hands to each player and the dealer, in order administer games of the present invention. The shuffler may be programmed to compare a rank of each player hand dealt to a dealer hand, which is dealt first or last according to house rules. The device may know that player 2 wins against the dealer hand and how much was won on the trips side bet, for example.

In some embodiments, the card-handling device 204 may be configured and programmed to administer at least a portion of a wagering game being played utilizing the card-handling device 204. For example, the card-handling device 204 may be programmed and configured to randomize a set of cards and present one or more cards for use according to game rules. More specifically, the card-handling device 204 may be programmed and configured to, for example, randomize a set of cards including one or more 52-card decks of standard playing cards and, optionally, any specialty cards (e.g., a cut card, bonus cards, wild cards, or other specialty cards). In some embodiments, the card-handling device 204 may present individual cards, one at a time, for withdrawal from the card-handling device 204. In other embodiments, the card-handling device 204 may present packets of cards representing a subset of the complete set of cards handled by the card-handling device 204 (e.g., individual hands, one hand at a time, a group of hands, a partial hand or hands and then additional cards as needed to complete the hand or hands, a hand or hands and any burn or specialty cards to be used in the same round as the hand or hands) for withdrawal from the card-handling device 204. In some such embodiments, the card-handling device 204 may accept dealer input, such as, for example, a number of replacement cards for discarded cards, a number of hit cards to add, or a number of partial hands to be completed. In other such embodiments, the device may accept a dealer input from a menu of game options indicating a game selection, which will select programming to deliver the requisite number of cards to the game, depending on the game rules. The game rules may be programmed into the memory of the shuffler processing system. In still other embodiments, the card-handling device 204 may present the complete set of randomized cards for withdrawal from the card-handling device 204. As specific, nonlimiting examples, the card-handling device 204 may present a packet of cards representing a single hand or a packet of cards representing a group of hands, each hand including five cards, as described previously in connection with FIG. 1.

Packets of cards used as player hands, partial player hands, dealer hands, partial dealer hands, community cards, or other card groups may be formed internally within the shuffler, such as within an internal compartment, as described in the '574 patent, or may be formed in an output tray of the shuffler. For example, U.S. Pat. No. 6,698,756, issued Mar. 2, 2004, to Baker et al. describes such a device. Other suitable shufflers include U.S. Pat. No. 6,267,248, issued Jul. 31, 2001, to Johnson et al, which describes a shuffler that can form a random set of cards, such as a deck or multiple decks, U.S. Pat. No. 7,766,332, issued Aug. 3, 2010, to Grauzer et al. which describes forming groups of player and/or dealer cards in compartments within a shuffler; U.S. Patent App. Pub. No. 2014/0027979, published Jan. 30, 2014, to Stasson et al., which shows an alternate method of randomly forming a set of cards in a shuffler such as one or more decks of cards; and U.S. Pat. No. 6,588,750, issued Jul. 8, 2003, to Grauzer et al., which shows a device for randomizing a set of cards using a gripping, lifting and insertion sequence. The disclosure of each of the foregoing documents is incorporated herein in its entirety by this reference.

In embodiments, the card handling device employs a random number generator device that may be used to determine a final card order, or an order of insertion of cards into a compartment configured to form a packet of cards. The compartments may be sequentially numbered, and a random number assigned to each compartment number prior to delivery of the first card. In other embodiments, the random number generator selects a location in the stack of cards to separate the stack into two sub-stacks, creating an insertion point within the stack at a random location. The next card is inserted into the insertion point. In yet other embodiments, the random number generator randomly selects a location in a stack to randomly remove cards by means of activating an ejector.

Other functions of the random number generator are game-specific. For example, a random number generator internal or external to the shuffler may be used to randomly determine a player to receive a first packet of cards, comprising a hand or a portion of a hand, according to the game rules. In other examples, the random number generator may select a game position to receive an extra card, one less card, or a random number of cards, depending upon the specific rules of the game.

Regardless of whether the random number generator is hardware or software, it may be used to implement specific game methods of the present disclosure.

The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc. The shuffler may also be configured to handle and dispense security cards, such as cut cards.

In some embodiments, the card-handling device 204 may include an electronic display 207 for displaying information related to the wagering game being administered. For example, the electronic display 207 may display a menu of game options, the name of the game selected, the number of cards per hand to be dispensed, acceptable amounts for wagers (e.g., maximums and minimums), numbers of cards to be dealt to recipients, locations of particular recipients for particular cards, winning and losing wagers, pay tables, winning hands, losing hands, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. For example, the card-handling device 204 may be configured to shuffle at least a physical deck of 53 cards, including a standard 52-card deck of playing cards and one joker. In some embodiments, additional cards may further be included in the deck, such as, for example, bonus cards (e.g., granting an automatic payout upon dealing and redemption or granting a prize or other award upon dealing and redemption) or security cards such as a cut card. As a specific, nonlimiting example, the card-handling device 204 may be a card shuffler or a combination card shuffler and shoe configured to randomize and present cards (e.g., in groups or one at a time) from at least a 53-card deck as described previously.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the drop box 214 and transfer physical wagering elements 212 to the player. The dealer 216 may accept one or more initial wagers (e.g., antes and other wagers) from the player, which may be reflected by the dealer 216 permitting the player to place one or more wagering elements 212 or other wagering tokens (e.g., cash) within designated areas on the gaming surface 202 associated with the various wagers of the wagering game. Once initial wagers have been accepted, the dealer 216 may remove physical cards 206 from the card-handling device 204 (e.g., individual cards, packets of cards, or the complete set of cards) in some embodiments. In other embodiments, the physical cards 206 may be hand-pitched (i.e., the dealer may optionally shuffle the cards 206 to randomize the set and may hand-deal cards 206 from the randomized set of cards). The dealer may position cards 206 within designated areas on the gaming surface 202, which may designate the cards 206 for use as individual player cards, community cards, or dealer cards in accordance with game rules. House rules also may allow the player to place wagers during card distribution, or after card distribution, but before revealing the cards.

After dealing the cards 206, and during play, according to the game rules, any additional wagers (e.g., play bets) may be accepted, which may be reflected by the dealer 216 permitting the player to place one or more wagering elements 212 within designated areas on the gaming surface 202 associated with the various wagers of the wagering game. In some embodiments, a player may fold, which may result in the dealer 216 collecting at least one of the wagering elements 212 from that player and transferring it to the house, which may be reflected by the wagering element 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering elements 212 from the chip rack 208 to the players, and transferring losing wagers to the house, which may be accomplished by moving wagering elements 212 from the players to the chip rack 208.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc.) and accepting player elections. The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices (not shown) through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

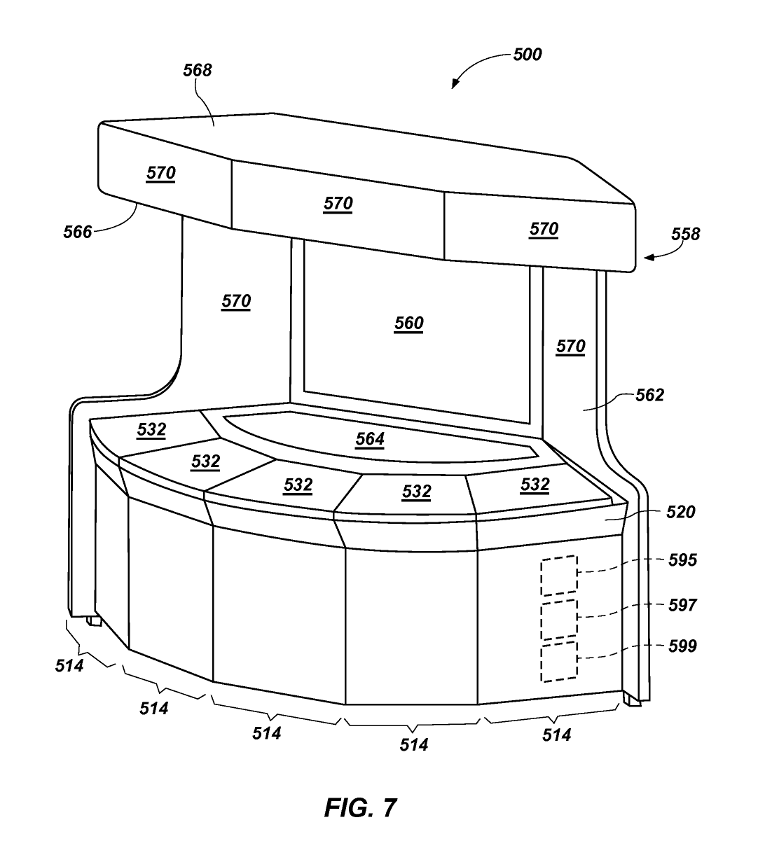

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514a through 514e.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 can comprise a variety of implementations according to the user device 620 and method of communication with the gaming servers 610. In one embodiment, the user device 620 connects to the gaming servers 610 using a web browser, and the client executes within a browser window or frame of the web browser. In another embodiment, the client is a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” As that term is used herein, the client may be little more than a script player. The client may simply send requests to the gaming servers 610 rather than performing logic itself. The client receives player inputs, and the player inputs are passed to the gaming servers 610 for processing and executing the wagering game. In one embodiment, this includes providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be configured to perform game play methods and determine game play outcomes that are provided to the user interaction service 612 to be transmitted to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 also performs random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. As such, the user device 620 can be a desktop computer, a laptop, a tablet computer, a set-top box, a mobile device (e.g., a smart phone), a kiosk, a terminal, or another computing device. As a specific, nonlimiting example, the user device 620 operating the client may comprise an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In some embodiments, these functions are operated by the same administrator. For example, a gaming entity (e.g., a casino) may elect to perform each of these functions in-house, such as providing both the access to the user device 620, delivering the actual game content, and administering of the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

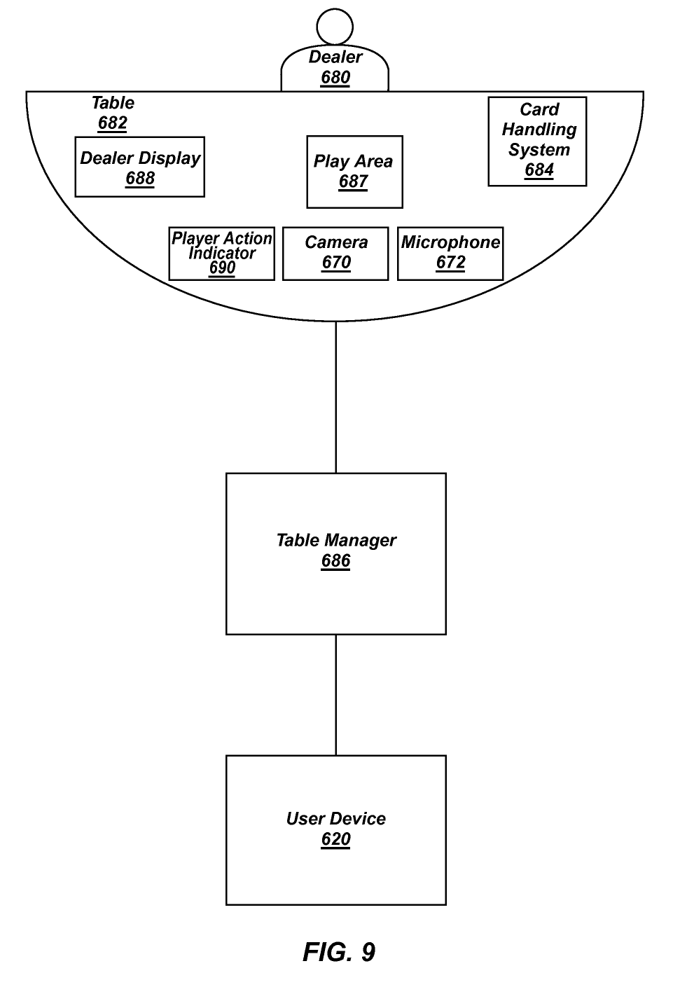

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by a computerized random processes, physical cards (e.g., from a standard, 52-card deck of playing cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card handling system 684 may be as shown and described previously in connection with FIG. 4. The play area 686 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

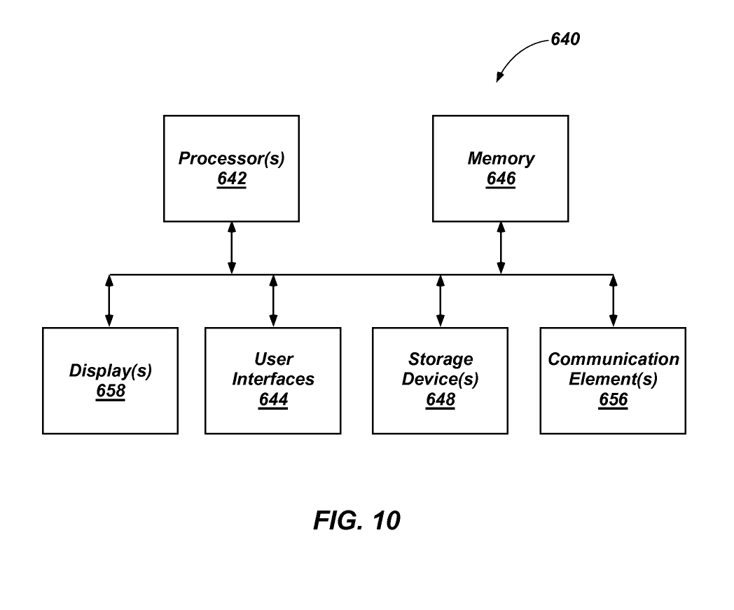

FIG. 10 is a simplified block diagram showing elements of computing devices that may be used in systems and apparatuses of the present disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for carrying out embodiments of the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As nonlimiting examples, the user interface elements 644 may include elements such as displays, keyboards, push-buttons, mice, joysticks, haptic devices, microphones, speakers, cameras, and touchscreens.

As nonlimiting examples, the communication elements 656 may be configured for communicating with other devices or communication networks. As nonlimiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of non-volatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting busses between the various elements. Moreover, the various elements may be subdivided physically, functionally, or a combination thereof. As one nonlimiting example, the memory 646 may be divided into cache memory, graphics memory and main memory. Each of these memories may communicate directly or indirectly with the one or more processors 642 on separate busses, partially-combined busses, or a common bus.

In some embodiments, wagering games may be administered in an at least partially player-pooled format, with payouts on pooled wagers being paid from a pot to players and losses on wagers being collected into the pot and eventually distributed to one or more players. Such player-pooled embodiments may include a player-pooled progressive embodiment, in which a pot is eventually distributed when a predetermined progressive-winning hand combination or composition is dealt. Player-pooled embodiments may also include a dividend refund embodiment, in which at least a portion of the pot is eventually distributed in the form of a refund distributed, e.g., pro-rata, to the players who contributed to the pot.

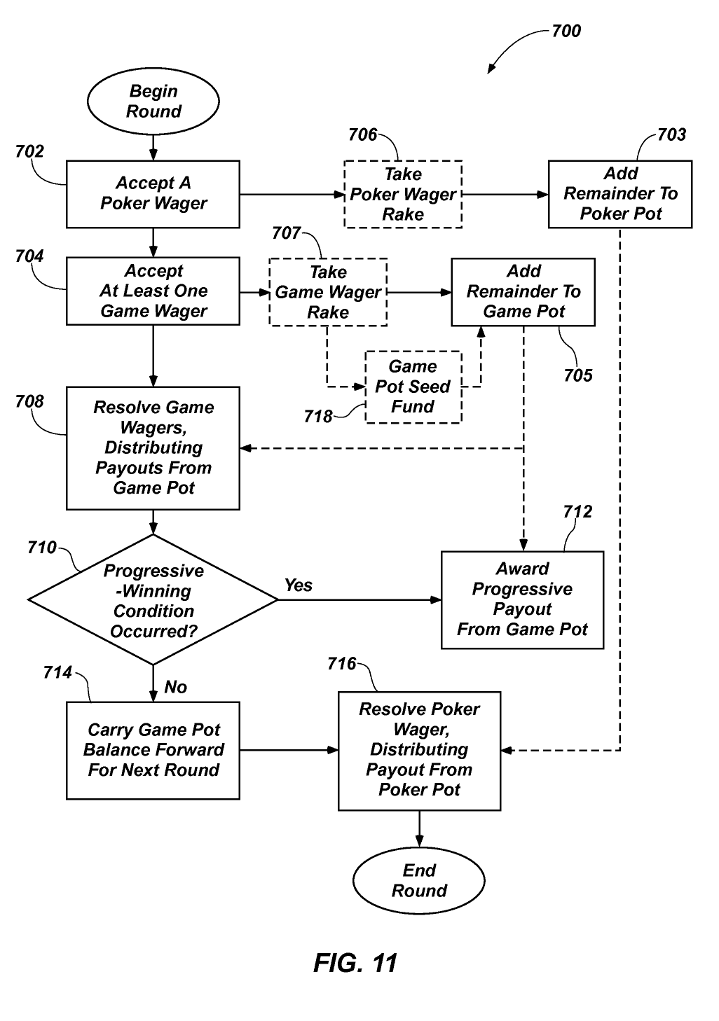

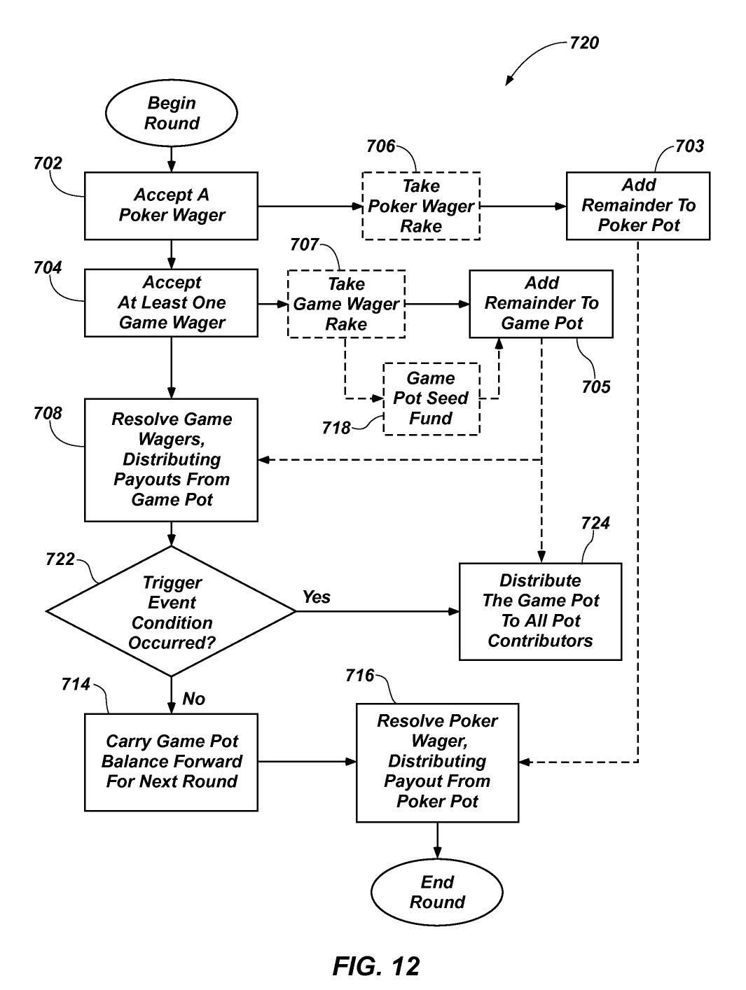

In some player-pooled embodiments, the game administrator may not obtain profits from chance-based events occurring in the wagering games that result in lost wagers. Instead, lost wagers may be redistributed back to the players. To profit from the wagering game, the game administrator may retain a commission, such as, for example, a player entrance fee or a rake taken on wagers, such that the amount obtained by the game administrator in exchange for hosting the wagering game is limited to the commission and is not based on the chance events occurring in the wagering game itself. The game administrator may also charge a rent of flat fee to participate. Specific, illustrative mechanisms for redistributing the lost wagers back to players are described in connection with FIGS. 11 and 12.

Referring to FIG. 11, shown is a flowchart diagram of a method 700 of administering a wagering game, which may be at least partially player-pooled, according to a player-pooled progressive embodiment. The method 700 includes accepting a first mandatory wager, referred to herein as a “poker wager,” as indicated at operation 702. At least a portion of the poker wager is added to a poker pot, as indicated at operation 703. The poker wager may be later resolved by comparing player hands and awarding the poker pot, or at least a portion thereof, to the player holding the highest ranked five-card poker hand when compared to the five-card poker hands held by other players. The player hands may be ranked according to known five-card poker rankings for games played with wild cards (e.g., in descending order: all wild cards, royal flush, straight flush, five of a kind, four of a kind, full house, flush, straight, three of a kind, two pair, one pair, and high card).

The poker pot may be a non-progressive pot in that all or substantially all of the poker pot may be distributed at the conclusion of each round of administration of the wagering game. In some embodiments, the poker wager may be a mandatory wager to qualify the player for play of the underlying wagering game. In other embodiments, the poker wager may be optional, and the wagering game may be administered to a player without receiving the poker wager and without qualifying the player for a potential payout from the poker pot.

At least one game wager may also be accepted, as indicated at operation 704. The game wagers may include, for example, a base game wager (e.g., ante wagers, blind wagers, play wagers, raises, and other wagers made on the underlying wagering game) and/or a side wager. More specifically, the game wagers may comprise, for example, any or all of the ante, blind, play, trips, and coverall wagers described previously in connection with FIG. 1. The at least one game wager may be accepted, for example, by performing any of the acts described previously in connection with FIG. 1. At least a portion of the at least one game wager is added to a game pot, as indicated at operation 705, which game pot may be a progressive pot.

In some embodiments, acceptance of the at least one game wager qualifies a player to be eligible to win an award in addition to the payouts available from the underlying game (i.e., the payouts on the ante, blind, play, trips, and coverall wagers), such as, for example, a progressive payout (e.g., a progressive jackpot awarded to one or more qualifying players). Therefore, in some such embodiments, a progressive wager may be received, in addition to the other game wagers received from the player, such as the ante, blind, play, trips, and coverall wagers. In other such embodiments, one of the game wagers may be converted to a progressive wager, such as, for example, ante, blind, play, trips, and coverall wagers. In some embodiments, the progressive wager may be a mandatory wager to qualify the player for play of the underlying wagering game. In other embodiments, the progressive wager may be optional, and the wagering game may be administered to a player without receiving the progressive wager, in addition to any other game wagers, from the player and without qualifying the player to be eligible to win the progressive payout from the game pot.

In some embodiments, the poker wager and the at least one game wager may be received as indistinct wagers, with a portion thereof being designated for the poker pot (a non-progressive pot) and another portion being designated for the game pot (a progressive pot).

In some embodiments, the game pot may be a pooled or linked pot. For example, the game pot may include one or more game wagers accepted from multiple concurrent wagering games. As another example, the game pot may include pooled progressive wagers from those wagering games currently being played and/or may include accumulated game wagers from past wagering games. As specific, nonlimiting examples, the game pot may include all game wagers accepted from a group of electronic gaming tables or other local wagering game administration devices at a casino, from multiple groups of remote devices connected to network gaming architecture, or both. In other embodiments, the game pot may not be pooled, and awards for the game wager may be limited to the amounts wagered at a respective electronic gaming table, other local wagering game administration device, or group of remote devices.

The game administrator may take a “rake” (e.g., a commission for the house) on at least one wager, such as the poker wager, as indicated at operation 706, the at least one game wager, as indicated at operation 707, or both. In some embodiments, therefore, a rake may be taken on all wagers, or any wager. For example, the house may collect a portion of the poker wager at the time the poker wager is placed. Additionally or alternatively, the house may collect a portion of the game wagers at the time the game wagers are placed.

The rake may be, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the wagers (i.e., either or both of the poker wager and the at least one game wager) collected for the rake may be between 3% and 8%, between 4% and 7%, or between 5% and 6%. In other embodiments, the portion of the wagers collected for the rake may comprise a variable percentage of the wagers or may comprise a fixed quantity (e.g., a flat fee) irrespective of the total amount for the wagers, a fixed percentage with a cap, or a time-based fee for increments of time playing the wagering game. Thus, in lieu of, or in addition to, a rake taken on one or more wagers, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some player-banked embodiments. In such embodiments, wagered amounts in excess of the rake are distributed either in the form of, for example, a progressive payout (as in a “player-pooled progressive” embodiment (FIG. 11)), a dividend refund (as in a “dividend refund” embodiment (FIG. 12)), or some combination thereof. Thus, the profits for the house are limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., ante, blind, play, trips, and coverall wagers), including losses resulting from optimal and suboptimal play.

The rake may be maintained in a rake account, and profits for the house may be deducted from the rake account. When and if taken from the poker wagers, the poker wager rake (operation 706) may be taken by, for example, electronically transferring funds from the poker wagers to a poker pot rake account (e.g., as instructed by a game service 616 (see FIG. 8) using casino account servers 632 (see FIG. 8)). Likewise, when and if taken from the game wagers, the game wager rake (operation 707) may be taken by, e.g., electronically transferring funds from the game pot wagers to a game pot rake account (e.g., as instructed by the game service 616 (see FIG. 8) using casino account servers 632 (see FIG. 8)).

In some embodiments, the poker wager may be accepted (operation 702) at the beginning of a round of administration of the wagering game. One or more of the game wagers may be accepted (operation 704) at the beginning of the round as well, e.g., the ante, blind, trips, and coverall wagers. In some embodiments, additional game wagers may be accepted (operation 704), possibly raked (operation 707), and added to the game pot (operation 705) in the intermediate segments of the round of play, e.g., the play wager.

The underlying wagering game may be played as described above, including resolving the game wagers received during the round of play, as indicated at operation 708. For example, the underlying wagering game may be played at least substantially as described previously in connection with FIGS. 1 through 3. In some embodiments, rather than comparing each individual player hand to a dealer hand, the individual player hands may be compared to one another, and the only hand eligible to win the ante, blind, and play wagers may be the highest-ranked player hand. In other embodiments, a dealer hand may still be dealt, even though the ante, blind, and play wagers are not played against the house. Payouts to be distributed, as a result of resolving the game wagers, (e.g., payouts on the ante, blind, play, trips, and coverall wagers), are paid from the game pot.

It is contemplated that only a portion of the game pot may be distributed, at operation 706, in the form of payouts on the underlying game. At least in embodiments in which the game pot is configured as a progressive pot (e.g., if one of the game wagers is a progressive wager or one game outcome of a low frequency pays the amount of the pot), all or substantially all of the remaining portion of the game pot may be designated for a potential progressive payout. For example, administering the player-pooled progressive embodiment of the player-pooled wagering game may include determining whether a progressive-winning condition has occurred, as indicated at operation 710. A progressive-winning condition may be predefined as a predetermined winning hand combination being dealt or a premium winning hand composition being dealt. If such a progressive-winning condition has occurred during the round of game administration, a progressive payout may be awarded to the winning-hand-holding player, with the progressive payout being paid from the game pot, as indicated at operation 712. As just one example, a game may pay a progressive payout for holding a player hand that outranks all other players' hands and is one of a set of predetermined winning hands or higher or for holding a player hand that outranks the dealer hand and is one of a set of predetermined winning hands. If no progressive-winning condition has occurred, a progressive payout may not be paid from the game pot, but, rather, the game pot balance may be carried forward for the next round of play and so on, as indicated at operation 714, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts distributed at operation 708, or if a progressive payout is awarded at operation 712, without draining the game pot, the game pot may decrement until the game pot contributions, at operation 705, rebuild the game pot.

A predetermined winning hand combination may comprise, for example, a four-of-a-kind, a full house, a flush, a straight, a three-of-a-kind, two pair, or one pair. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may comprise, for example, a four-of-a-kind, a straight flush, or a royal flush. The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, nonlimiting example, after identification of a player hand achieving a straight flush, the hand compositions qualifying as premium winning hand compositions may be restricted to royal flushes or may be expanded to include four-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may involve crediting a player account with funds from the game pot or may comprise distributing physical money or physical representations of money from the game pot to the player.

Before, between, or after resolving the game wagers (operation 708), determining whether a progressive-winning condition occurred (operation 710), awarding a progressive payout (operation 712), or any combination thereof, the poker wager may be resolved, and the poker pot may be awarded to at least one player, as indicated at operation 716. Each successive round of receiving wagers, dealing cards, and resolving wagers may constitute a round of play, and the poker pot may be awarded to at least one player before the end of each round of play. The player to whom the poker pot is awarded may hold a highest ranked five-card poker hand when compared to the hands of other players at the virtual “table.”

Awarding the poker pot or the portion of the poker pot may comprise crediting a player account of each winning player or may comprise distributing physical money or physical representations of money to each winning player.

In some embodiments, an entire amount of the poker pot may be awarded to at least one player before the end of each round of play. In such embodiments, the poker pot may be a non-progressive pot. Awarding the entire poker pot to at least one player at the end of each round of play may enable an online implementation of the wagering game to qualify as a legal form of online gambling under relevant statutes.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 718) at the beginning of play, after the game pot or a portion of the game pot has been awarded, or both. In some embodiments, a minimum account balance sufficient to cover expected losses is retained when distributing a progressive payout (operation 712) such that no seed money is required in the game pot. For example, the game pot may be seeded from the rake account of the house (operation 718), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed-odds payout is to be awarded to the player holding the predetermined winning hand combination, the amount seeded to the game pot between those rounds of play may be at least as great as the maximum fixed-odds payout awardable for any predetermined winning hand combination. The game pot may be seeded each time the game pot is awarded in its entirety or each time the amount in the game pot is lower than the maximum fixed-odds payout.

FIG. 12 is a flowchart diagram of a method 720 of administering a wagering game, which may be at least partially player-pooled, according to a dividend refund embodiment. The method 720 is largely the same as the method 700 of the player-pooled progressive (FIG. 11), with the exception that, rather than determining whether a progressive-winning condition has occurred (operation 710 (FIG. 11)), the method 720 includes determining whether a trigger event condition has occurred, as indicated at operation 722, and, if so, distributing the game pot to one or more past or present players of the wagering game, as indicated at operation 724 (rather than distributing the game pot as a progressive payout as at operation 712 (FIG. 11)). In such embodiment, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but a refund.

The game pot may be distributed among a plurality of players upon the occurrence of a predetermined event (referred to herein as a “trigger event”), as indicated at operation 722. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, amount-based, or other-based. Further details on pot distributions based on predetermined trigger events and conditions are disclosed in the U.S. patent application Ser. No. 13/871,824, filed Apr. 26, 2013, titled “DISTRIBUTING SUPPLEMENTAL POT IN WAGERING GAMES BASED ON PREDETERMINED EVENT,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in her player account.

In some embodiments, wagering games may be administered over a network without players risking money in connection with the wagers (i.e., “play-for-fun” games). Access to play-for-fun wagering games may be granted on a time period basis in some embodiments. For example, upon initially joining the wagering game, each player may automatically be given wagering elements, such as, for example, chips, points, or simulated currency, that is of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time another quantity of the wagering elements may be distributed to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the ante, blind, play, trips, and coverall wagers) of no real-world monetary value, and payouts (e.g., the payouts on the ante, blind, play, trips, and coverall wagers) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventor.

1. A method of administering a wagering game, comprising:
accepting a mandatory ante wager from a player on a game of five-card stud poker played against a dealer hand by receiving a physical, monetarily valuable wagering element in a first designated area on a surface of a gaming table;
accepting a mandatory blind wager that a hand dealt to the player will qualify as a predetermined winning hand from the player by receiving a physical, monetarily valuable wagering element in a second designated area on the surface of the gaming table, the second designated area being separate and distinct from the first designated area;
dealing five randomized physical cards to the player and to the dealer hand from a 53-card deck including a standard 52-card deck of playing cards and one joker, the joker and four deuces being designated as wild cards;
accepting a play wager from the player by receiving a physical, monetarily valuable wagering element on the surface of the gaming table, responsive to which the ante and blind wagers remain in play by leaving the wagering elements associated with the ante and blind wagers in the first and second designated areas, respectively, or accepting a player election to fold, responsive to which the wagering elements associated with the ante and blind wagers are physically collected;
resolving the ante and play wagers by comparing the dealer hand to a player hand held by the player;
paying a payout on the ante and play wagers to the player when the player hand outranks the dealer hand by physically transferring wagering elements to the player and physically collecting the wagering elements associated with the ante and play wagers when the dealer hand outranks the player hand;
resolving the blind wager by comparing the dealer hand to the player hand and comparing the player hand to a set of predetermined winning hands; and
paying a payout on the blind wager to the player when the player hand outranks the dealer hand and the player hand is a predetermined winning hand by physically transferring wagering elements to the player, returning the blind wager to the player when the player hand outranks the dealer hand and the player hand is not a predetermined winning hand by physically transferring the wagering element associated with the blind wager to the player, and physically collecting each wagering element associated with the blind wager when the dealer hand outranks the player hand, regardless of whether the player hand is a predetermined winning hand.

2. The method of claim 1, further comprising:
accepting a trips wager from the player that a hand dealt to the player will be ranked three of a kind or higher by receiving a physical, monetarily valuable wagering element in a third designated area on the surface of the gaming table, the third designated area being separate and distinct from the first and second designated areas;
resolving the trips wager by determining whether the player hand is ranked three of a kind or higher; and
paying a payout on the trips wager to the player when the player hand is ranked three of a kind or higher by physically transferring wagering elements to the player, and physically collecting each wagering element associated with the trips wager when the player hand is ranked lower than three of a kind.

3. The method of claim 2, wherein paying the payout on the trips wager comprises determining an amount of the payout, the amount of the payout being greater when the player hand achieves its rank without using any wild card as a wild card than when the player hand achieves its rank using a wild card as a wild card.

4. The method of claim 3, wherein determining the amount of the payout, the amount of the payout being greater when the player hand achieves its rank without using any wild card as a wild card than when the player hand achieves its rank using a wild card as a wild card, comprises determining the amount of the payout, the amount of the payout being greater when the player hand lacks a joker and lacks a deuce used as anything other than its displayed rank and suit than when the player hand achieves its rank using a joker or a deuce used as anything other than its displayed rank and suit.

5. The method of claim 1, further comprising:
accepting a coverall wager from the player that a hand dealt to any player or the dealer will be ranked four of a kind or higher by receiving a physical, monetarily valuable wagering element in a third designated area on the surface of the gaming table, the third designated area being separate and distinct from the first and second designated areas;
resolving the coverall wager by determining whether any player hand or the dealer hand is ranked four of a kind or higher; and
paying a payout on the coverall wager to the player when any player hand or the dealer hand is ranked four of a kind or higher by physically transferring wagering elements to the player, and physically collecting each wagering element associated with the coverall wager when all player hands and the dealer hand are ranked lower than four of a kind.

6. The method of claim 5, wherein paying the payout on the coverall wager comprises determining an amount of the payout, the amount of the payout being greater as the number of participating players decreases.

7. The method of claim 5, further comprising accepting another coverall wager from another player and paying another payout on the other coverall wager when any player hand or the dealer hand is ranked four of a kind or higher by physically transferring wagering elements to the other player, amounts of the payouts paid to the player and the other player being equal to one another.

8. The method of claim 1, further comprising:
accepting a progressive wager from the player that the player hand will be of a predetermined rank or higher and transferring at least a portion of the progressive wager to a progressive pot;
resolving the progressive wager by comparing the player hand to a set of predetermined winning hands; and
paying a payout on the progressive wager from the progressive pot to the player when the player hand is of the predetermined rank or higher, wherein an amount of the payout is greater when the player hand achieves its rank without using any wild card as a wild card than when the player hand achieves its rank using a wild card as a wild card for at least some predetermined winning hands of the set of predetermined winning hands.

9. The method of claim 8, wherein paying the payout comprises paying an entire amount of the progressive pot to the player when the player hand is composed of wild cards.

10. The method of claim 1, further comprising:
accepting a bad beat wager from the player that the player hand will be outranked by the dealer hand and will be of a predetermined rank or higher;
resolving the bad beat wager by comparing the player hand to the dealer hand and comparing the player hand to a set of predetermined winning hands; and
paying a payout on the bad beat wager to the player when the player hand is outranked by the dealer hand and the player hand is of the predetermined rank or higher.

11. The method of claim 1, wherein accepting the mandatory ante wager and accepting the mandatory blind wager comprise accepting the mandatory ante wager and the mandatory blind wager in amounts of equal monetary value.

12. The method of claim 1, further comprising returning the ante, blind, and play wagers to the player when the player hand is of the same rank as the dealer hand by physically transferring the wagering element associated with the ante, blind, and play wagers to the player.

13. A method of administering a wagering game, comprising:
accepting a mandatory ante wager from a player on a game of five-card stud poker played against a dealer hand by receiving a physical, monetarily valuable wagering element in a first designated area on a surface of a gaming table;
accepting a mandatory blind wager that a hand dealt to the player will qualify as a predetermined winning hand from the player by receiving a physical, monetarily valuable wagering element in a second designated area on the surface of the gaming table, the second designated area being separate and distinct from the first designated area;
dealing five randomized physical cards to the player and to the dealer hand from a 53-card deck including a standard 52-card deck of playing cards and one joker, the joker and four deuces being designated as wild cards;
accepting a mandatory play wager from the player by receiving a physical, monetarily valuable wagering element on the surface of the gaming table, responsive to which the ante and blind wagers remain in play by leaving the wagering elements associated with the ante and blind wagers in the first and second designated areas, respectively;
resolving the ante and play wagers by comparing the dealer hand to a player hand held by the player;
paying a payout on the ante and play wagers to the player when the player hand outranks the dealer hand by physically transferring wagering elements to the player and physically collecting the wagering elements associated with the ante and play wagers when the dealer hand outranks the player hand;
resolving the blind wager by comparing the dealer hand to the player hand and comparing the player hand to a set of predetermined winning hands; and
paying a payout on the blind wager to the player when the player hand outranks the dealer hand and the player hand is a predetermined winning hand by physically transferring wagering elements to the player, returning the blind wager to the player when the player hand outranks the dealer hand and the player hand is not a predetermined winning hand by physically transferring the wagering element associated with the blind wager to the player, and physically collecting each wagering element associated with the blind wager when the dealer hand outranks the player hand, regardless of whether the player hand is a predetermined winning hand.

14. The method of claim 13, further comprising:
accepting a mandatory trips wager from the player that a hand dealt to the player will be ranked three of a kind or higher by receiving a physical, monetarily valuable wagering element in a third designated area on the surface of the gaming table, the third designated area being separate and distinct from the first and second designated areas;
resolving the trips wager by determining whether the player hand is ranked three of a kind or higher; and
paying a payout on the trips wager to the player when the player hand is ranked three of a kind or higher by physically transferring wagering elements to the player, and physically collecting each wagering element associated with the trips wager when the player hand is ranked lower than three of a kind.

15. (canceled)

16. (canceled)

17. The method of claim 13, further comprising:
accepting a mandatory coverall wager from the player that a hand dealt to any player or the dealer will be ranked four of a kind or higher by receiving a physical, monetarily valuable wagering element in a third designated area on the surface of the gaming table, the third designated area being separate and distinct from the first and second designated areas;
resolving the coverall wager by determining whether any player hand or the dealer hand is ranked four of a kind or higher; and
paying a payout on the coverall wager to the player when any player hand or the dealer hand is ranked four of a kind or higher by physically transferring wagering elements to the player, and physically collecting each wagering element associated with the coverall wager when all player hands and the dealer hand are ranked lower than four of a kind.

18. The method of claim 17, wherein paying the payout on the coverall wager comprises determining an amount of the payout, the amount of the payout being greater as the number of participating players decreases.

19. The method of claim 17, further comprising accepting another mandatory coverall wager from another player and paying another payout on the other coverall wager when any player hand or the dealer hand is ranked four of a kind or higher by physically transferring wagering elements to the other player, amounts of the payouts paid to the player and the other player being equal to one another.

20. The method of claim 13, further comprising:
accepting a progressive wager from the player that the player hand will be of a predetermined rank or higher and transferring at least a portion of the progressive wager to a progressive pot;
resolving the progressive wager by comparing the player hand to a set of predetermined winning hands; and
paying a payout on the progressive wager from the progressive pot to the player when the player hand is of the predetermined rank or higher, wherein an amount of the payout is greater when the player hand achieves its rank without using any wild card as a wild card than when the player hand achieves its rank using a wild card as a wild card for at least some predetermined winning hands of the set of predetermined winning hands.

21. The method of claim 20, wherein paying the payout comprises paying an entire amount of the progressive pot to the player when the player hand is composed of wild cards.

22. The method of claim 13, further comprising:
accepting a bad beat wager from the player that the player hand will be outranked by the dealer hand and will be of a predetermined rank or higher;
resolving the bad beat wager by comparing the player hand to the dealer hand and comparing the player hand to a set of predetermined winning hands; and
paying a payout on the bad beat wager to the player when the player hand is outranked by the dealer hand and the player hand is of the predetermined rank or higher.

23-26. (canceled)
